(19) United States
(12) Patent Application Publication
(10) Pub. No.: US 2004/0035111 A1
(43) Pub. Date: Feb. 26, 2004

(54) Method and device for producing steam by means of solar energy

(76) Inventors: Livien Domien Ven, Antwerpen (BE); Michel Sureda, Borgerhout (BE)

Correspondence Address: BACON & THOMAS, PLLC, 625 SLATERS LANE, FOURTH FLOOR, ALEXANDRIA, VA, 22314

(21) Appl. No.: 10/363,865

(22) PCT Filed: Sep. 12, 2001
(86) PCT No.: PCT/BE01/00150

(30) Foreign Application Priority Data
Sep. 19, 2000 (BE) 20000597

(51) Int. Cl. F03G 6/00; B60L 8/00; B60K 16/00

(52) U.S. Cl. 60/641.8

(57) ABSTRACT

The invention relates to a method for producing steam by means of solar energy, whereby water is brought into a field of tubes comprising a number of approximately horizontal metal tubes (2) and concentrators (3) of solar radiation directed onto these tubes (2), whereby in a heating part (14) of this field of tubes (1), water is heated, this water, in a saturation part (15) of the field of tubes (1) having a number of parallel tubes (2) connecting to the heating part (14), is transformed into saturated steam and, in a superheating part (16) of the field of tubes (1), the saturated steam is superheated. In the aforementioned parallel tubes (2) of the saturation part (15), an amount of steam is supplied with such a speed that the water flows in these tubes (2) in a tubular shape against the interior wall.

This invention relates to a method for producing steam by means of solar energy, whereby water is brought into a field of tubes comprising a number of approximately horizontal metal tubes and concentrators of solar energy directed onto these tubes, whereby in a heating part of this field of tubes, water is heated, this water, in a saturation part of the field of tubes having a number of parallel tubes connected to the heating part, is transformed into saturated steam and, in a superheating part of the field of tubes, the saturated steam is superheated.

The metal tubes of the different parts form absorbers which are arranged in the focal line of the concentrators. These concentrators collect the solar radiation and, to this aim, follow the sun. They refract the solar radiation concentratedly onto a part of the tube, either directly or after an additional concentration and refraction onto a secondary concentrator which is arranged above the tube.

The superheated steam may be used for a variety of purposes, for example, for driving a steam turbine which is coupled to a generator.

A similar method is described in the Dutch patent application No. 1.008.355.

In the heating part, the tubes are entirely filled with water, and in the superheating part, they are entirely filled with steam, whereas in the saturation part, the tubes are comprising water as well as steam.

According to this known method, water from the heating part is distributed uniformly over the parallel tubes of the saturation part.

In the starting end of these parallel tubes, there is practically no steam. The more the other end is approached, the more the amount of steam increases.

In the beginning, this steam may have the shape of bubbles which become larger and larger as more and more heat is taken up and the other end of the tube is approached. After a distance, water will be at the bottom and steam thereabove.

As a consequence, the utilization of the heat of the tube, which, by means of the concentrators, is heated by the solar energy, is limited.

In fact, water takes up heat much better than does the already formed steam, but only a part of the wall of the tube is in contact with water.

Moreover, the bottom side of the tube is cooled off more by the water than the top side is cooled off by the steam, as a result of which the tube may warp.

The invention has as an aim to provide a method which avoids these disadvantages and with which, thus, the solar energy can be utilized more efficiently in the saturation part and the danger of warping of the tubes of this part is prevented.

According to the invention, this aim is achieved in that an amount of steam is brought into the parallel tubes of the saturation part connecting to the heating part, with such a speed that the water flows in these tubes in a tubular shape against the interior wall.

Thus, the water will cover the entire interior wall of these tubes, such that the heat transfer of these tubes is optimum. The water flow in tubular shape against the interior wall of a tube is obtained by means of a well-defined ratio between the speed of the steam and the speed of the water.

Preferably, the water which is supplied from the heating part to the parallel tubes of the saturation part, is expanded at the inlet of these tubes, such that there, as a result of the pressure reduction, immediately steam is generated, and this with such a speed that the water flows into the tubes in a tubular shape.

In this embodiment, the steam supplied to the parallel tubes thus is obtained by expansion of the water which flows from the heating part into the saturation part, and therefore there is no extra supply of steam from outside.

The expansion of the supplied warm water can be regulated such that the speed of the water is between 0.1 and 1 m/s and the speed of the steam between 0.6 and 2.5 m/s.

The expansion can take place with a pressure drop of approximately 50 bar, for example, from a pressure of 160 bar to a pressure of 110 bar.

In a particular form of embodiment of the invention, after sunset, the warm water still present in the heating part, instead of being added to the saturation part, is stored in an insulated reservoir and, when the sun is rising, the stored and still warm water from the reservoir is supplied to the heating part again.

This allows to still utilize the last warmth of the sun of the day for faster obtaining steam in the morning. If this last-mentioned water should be brought into the saturation part, it could not be utilized anyway, in consideration of the fact that at the time when the saturated steam, inasmuch as it still can be formed, reaches the superheating part, there is no or insufficient solar radiation for superheating said steam.

In another form of embodiment, the water being in the saturation part at sunset, still is entirely transformed into saturated steam and superheated in the superheating part while there is still sufficient solar energy, and to this aim, the supply of water to the saturation part is closed off at a certain time before sunset.

The invention also relates to a device which is particularly suited for applying the method according to the invention described in the aforegoing.

Thus, the invention relates to a device for producing steam by means of solar energy, which device comprises at least one field of tubes comprising a number of approximately horizontal metal tubes and concentrators of solar radiation directed onto these tubes, whereby this field of tubes comprises a heating part for heating water, a saturation part with at least a number of parallel tubes connecting to the heating part for transforming this water into saturated steam, and a superheating part for superheating the steam, and which is characterized in that at the inlet of the parallel tubes of the saturation part connecting to the heating part, means are present for bringing steam into said tubes.

These means may consist of an adjustable expansion valve in the inlet of said tubes which connect to the heating part.

Preferably, the heating part comprises a thermically insulated reservoir, the outlet of which is connected to the inlet of the heating part, whereas a return conduit connects the inlet of this heating part to the inlet of the reservoir.

With the intention of better showing the characteristics of the invention, hereafter, as an example without any limitative character, a preferred form of embodiment of a method and a device for producing steam according to the invention is described, with reference to the accompanying drawings, wherein:

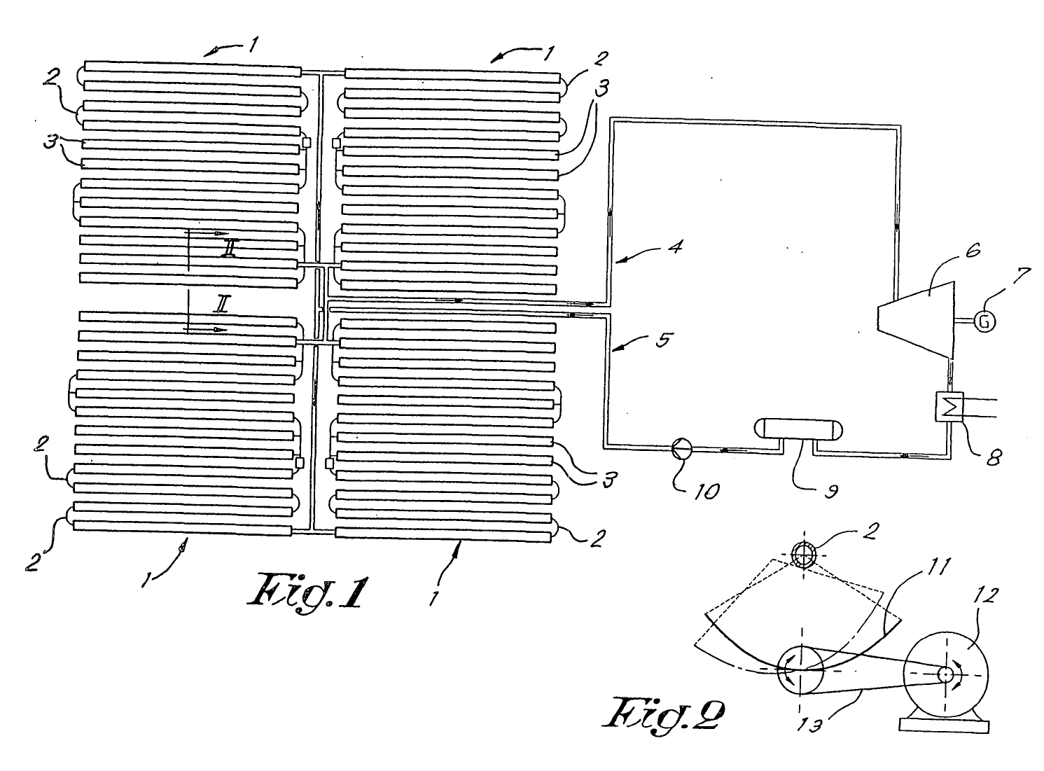

FIG. 1 schematically represents a view of a device for producing steam by means of solar energy according to the invention;

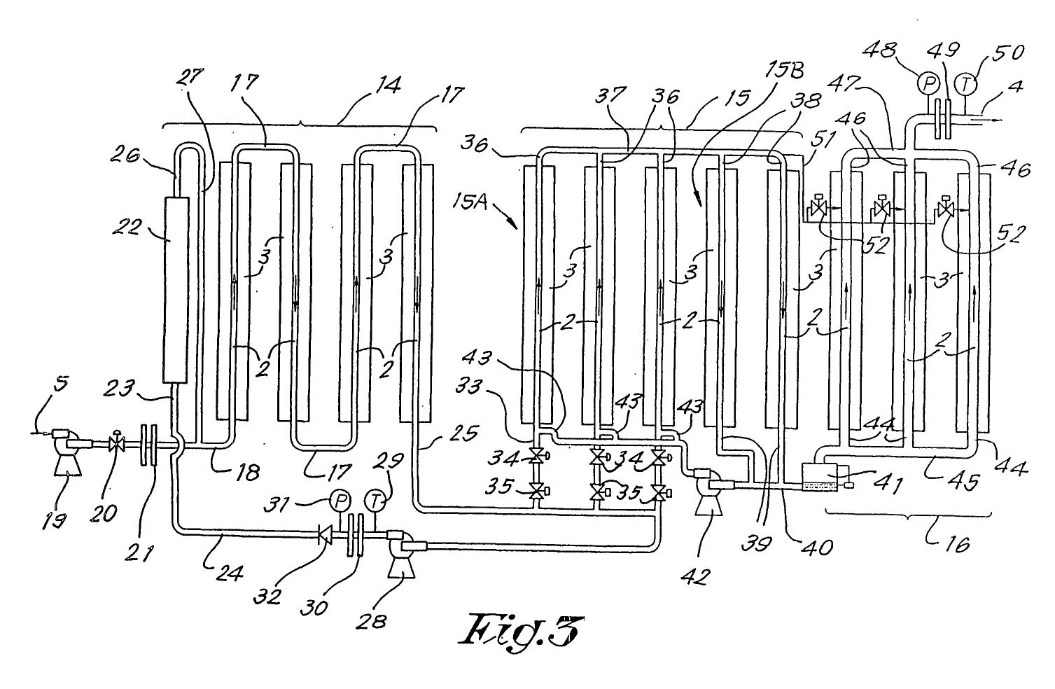

FIG. 2 schematically and at a larger scale represents a cross-section according to line II-II in FIG. 1;

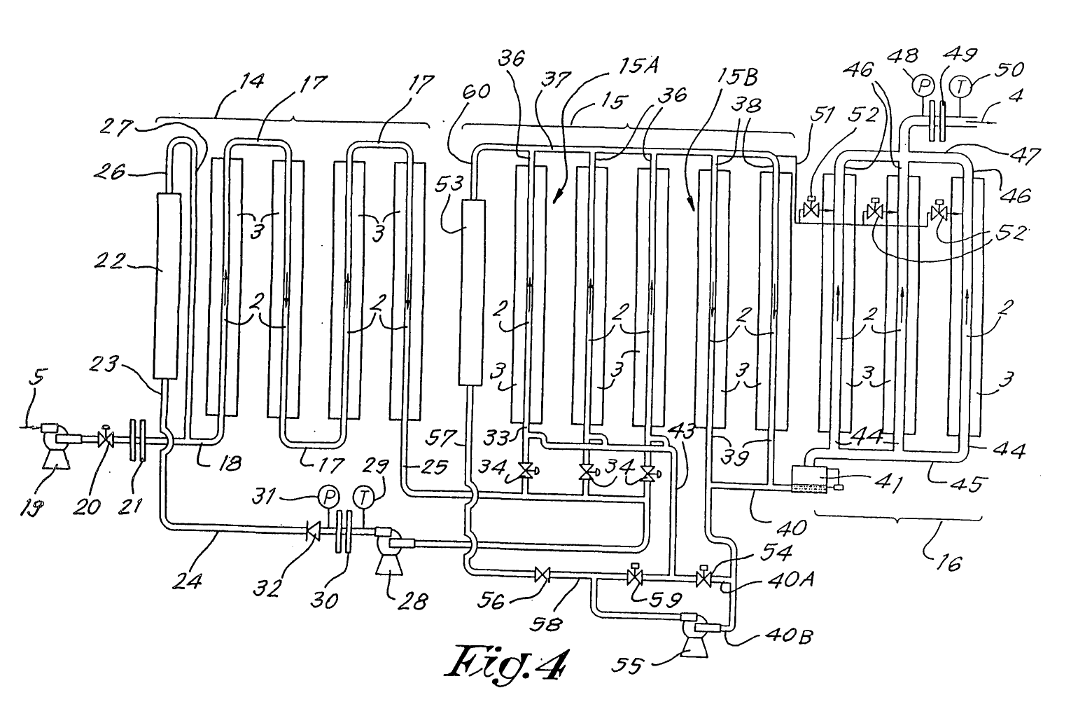

FIG. 3 schematically and at a larger scale represents a plan view of one of the fields of tubes from the device of FIG. 1;

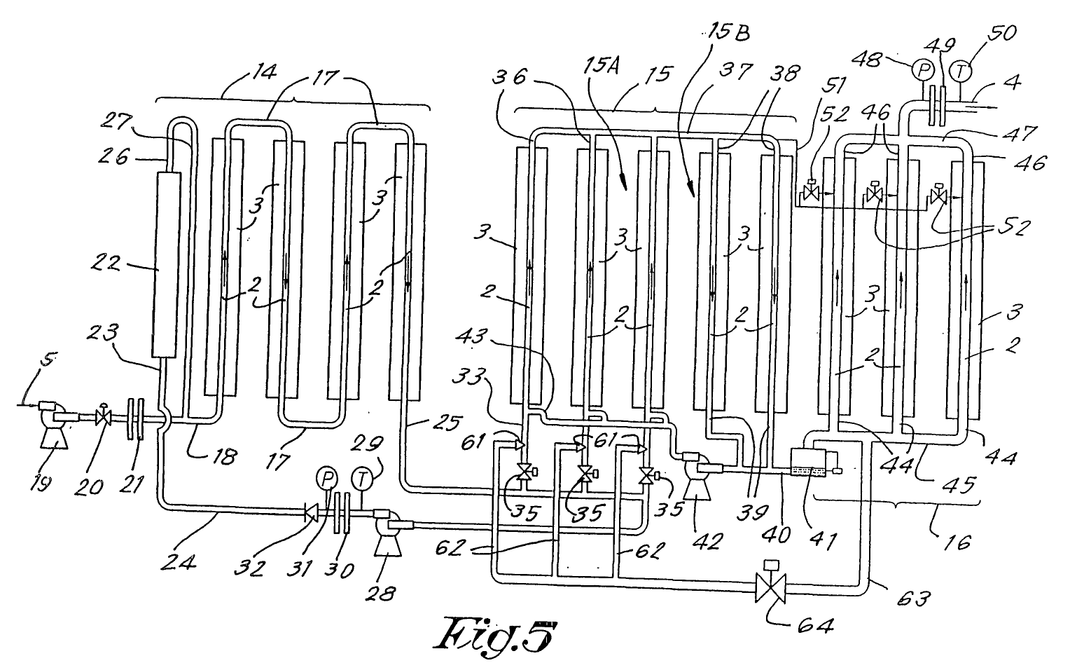

FIG. 4 schematically represents a plan view analogous to that of FIG. 3, however, in respect to another form of embodiment of the invention;

FIG. 5 schematically represents a plan view analogous to that of FIG. 3, however, in respect to still another form of embodiment of the invention.

As represented in FIGS. 1 and 2, a device for generating steam by means of solar energy according to the invention substantially consists of a number of fields of tubes 1 consisting of horizontal, metal, for example, steel tubes 2 and concentrators 3 cooperating therewith.

For example, the tubes 2 have an inner diameter of 20 cm and a length which can be up to 1000 m. They form absorbers and preferably are coated with a black heat-absorbing material.

The fields of tubes 1 are arranged parallel to each other and are connected, by means of steam conduits 4 and water conduits 5, to a steam turbine 6 which is coupled to a power generator 7. The fields of tubes and the steam turbine 6 together with the conduits 4 and 5 form a closed circuit in which, after the steam turbine, a condenser 8, a water reservoir 9 and a pump 10 are arranged.

Said concentrators 3 may have different forms. In its most simple form, a concentrator 3, as represented schematically in FIG. 2, consists of an oblong parabolically bent mirror 11, the focal line of which coincides with a tube 2. These mirrors 11 have, for example, a length of approximately 40 m.

By means of a motor 12, this mirror 11, by means of a transmission 13, is pivoted in order to continuously following the sun.

The concentrators 3 also may consist of strip-shaped mirrors, and an additional secondary concentrator may be arranged above the tube 2.

As represented in detail in FIG. 3, each field of tubes 1 consists of three parts, to wit a heating part 14 where water is heated up to the vaporization temperature and at a relatively high pressure, a saturation part 15 where the water is vaporized and saturated steam is produced, and a superheating part 16 where the saturated steam is superheated.

The saturation part 15 and the superheating part 16 are over-dimensioned, this means they are calculated too large and therefore may take up more solar energy than is necessary.

In the represented example, the heating part 14 comprises four tubes 2 arranged in series, this means, which are connected to each other at their extremities by means of connections 17.

In the inlet 18 of this heating part 14, successively a pump 19, a close-off valve 20 and a flow rate meter 21 are arranged.

The heating part 14 comprises a thermically insulated reservoir 22, the inlet 23 of which, by means of a return conduit 24, connects to the outlet 25 of the heating part 14, and the outlet 26, by means of a conduit 27, is connected to the inlet 18.

Between the outlet 25 and the inlet 23, in the return conduit 24 successively a pump 28, a thermometer 29, a flow rate meter 30, a pressure gauge 31 and a return valve 32 are arranged.

The saturation part 15 comprises five tubes 2, to wit one group 15A of three which are connected parallel to each other, and thereafter one group 15B of three which also are connected parallel to each other.

The three tubes 2 of the first group 15A are connected individually with their inlet 33, in which an expansion valve 34 and an adjustment valve 35 are provided, to the outlet 25 of the heating part 14.

With their outlet 36, said three tubes 2 connect to a collector pipe 37 with which the inlets 38 of the two tubes 2 of the second group 15B also are in connection.

The outlets 39 of these two tubes 2 are connected to a collector pipe 40 which gives out into a water separator 41.

The collector pipe 40 also gives out to a pump 42, the outlet of which, by means of conduits 43, gives out to the three inlets 33 of the group 15A.

The superheating part 16 comprises three tubes 2 connected in parallel manner, which are connected with their inlet 44 to a collector pipe 45 which gives out to the top side of the water separator 41 and thus only receives steam.

With their outlet 46, the three tubes 2 are connected to a collector pipe 47 which is connected to the steam conduit 4 in which a pressure gauge 48, a flow rate meter 49 and a thermometer 50 are arranged.

An injection conduit 51 connects the collector pipe 37 via adjustment valves 52 to the three tubes of the superheating part 16.

The functioning of the device is as follows:

In the tubes 2 of the heating part 14, the water pumped in by the pump 19 is heated by the solar energy up to boiling point, at a pressure of 110 or 160 bar.

When the sun sets, the supply of heat to this part, of course, stops. In this part, however, there is a large quantity of water which already is heated and, at the outgoing end of this heating part 14, even is at boiling temperature.

In order to prevent that this quantity of water cools down after sunset and has to be re-heated in the morning at sunrise before the boiling point is reached again at the outgoing end, which re-heating can take more than 1 hour, at sunset the hot water is pumped, by means of the pump 28, from the heating part 14 via the return conduit 24 to the reservoir 22 which is at the same pressure as the heating part 14 and has a capacity corresponding to the quantity of water in the heating part 14.

The colder water present in this reservoir 22, for example, water at 80° C., is pressed through outlet 26 out of this reservoir 22 into the heating part 14, such that the hot water from this part is completely replaced by this colder water.

At sunrise, the reverse takes place, to wit the colder water is pumped, by means of pump 28, out of heating part 14 and replaced by the hot water which has been stored the evening before in the reservoir 22 and, as this reservoir 22 is insulated, practically has not cooled off and, for example, still is above 300° C.

It is advantageous that the hottest water,has been stored first in the reservoir 22 and thus also first is pumped back into the heating part 14, such that after this pumping, the hottest water is in the proximity of the outlet 25 of the heating part 14.

As a consequence thereof, after sunrise the device can work faster at full power and, therefore, water at boiling point can flow rather fast to the saturation part 15.

In this saturation part 15, the hot water is transformed into steam. In the tubes 2, there is hot water as well as steam. In a tube 2, normal speeds can be obtained which may vary from 3 to 5 m/s for the water and from 60 to 100 m/s for the steam, however, according to the invention, the speed of the water is restricted to a value between 0.1 and 1 m/s and the speed of the steam to a value between 0.6 and 2.5 m/s.

It has been noted that in this manner, a tube-shaped flow has been achieved, whereby the water adjoins against the interior wall of the tubes 2 and the steam flows inside the “cylinder” of water.

In order to obtain this pattern already at the beginning of the saturation part 15 and therefore at the inlet 33 of the tubes 2 of the group 15A, at the location where normally no steam is present, anyhow a suitable quantity of steam must be supplied.

This is obtained by expanding the supplied boiling water by means of the expansion valves 34, with a pressure drop of 50 bar, for example, from the 110 or 160 bar prevailing in the heating part 14 to 60 bar, 100 bar, respectively.

By this expansion, at the inlet 33 steam will be formed immediately. The steam speed can be regulated by means of the expansion valves 34, and also the adjustment valves 35 may help therewith.

Due to the tubular-shaped flow of water against the tube wall in the saturation part, the tubes 2 are heated uniformly, and the taking up of solar energy is optimum.

The little bit of water which is still present in the saturated steam at the outlet 39, is separated in the water separator 41 and, by means of the pump 42, can be pumped via conduits 43 towards the inlets 33 of the tubes 2 of the first group 15A.

In the superheating part 16, the saturated steam of the saturation part 15 is superheated in order to be finally directed towards the steam conduit 4 to the steam turbine 6.

A regulation of the temperature in this overheating part 16 may take place by injecting an amount of saturated steam from the collector pipe 37 through the injection conduit 51 into one or more of the tubes 2 of this part 16.

The form of embodiment of the device represented in FIG. 4 differs from the form of embodiment described heretofore substantially in that also the saturation part 15 comprises a thermically insulated reservoir 53 which is arranged in a parallel manner in respect to the three tubes 2 of the group 15A and that the adjustment valves 35 are omitted.

At its side distant from the water separator 41, the collector pipe 40 comprises two branches, to wit a branch 40A which, through an adjustment valve 54, connects to the conduits 43, and a second branch 40B with therein a pump 55 and a closing element 56 connected to the inlet 57 of the reservoir 53. Between the two branches 40A and 40B, a conduit 58 is provided with therein an adjustment valve 59.

The outlet 60 of the reservoir 53 connects to the collector pipe 37.

The functioning of the device is similar to the functioning described in the aforegoing, with the difference that, at sunset or when the sun temporarily is not shining during the day, the closing element 56 is opened, whereas the adjustment valves 54 and 59 are closed and the water from the saturation part 15, by means of pump 55, is pumped through branch 40B to the reservoir 53.

Water pressed out of this reservoir 53 will get through outlet 60 into collector pipe 37.

The steam which is present in the saturation part 15, is discharged from this part, for example, by means of the superheating part 16, where it, however, is not necessarily superheated, and is directed towards an evaporator of, for example, an desalinization device.

At sunrise or when the sun shines again, by means of the pump 55 the water which is now in the saturation part 15 can be pumped to the reservoir 53, as a result of which the stored water from this reservoir 53 is pumped back to the saturation part 15 and more particularly into the collector pipe 37.

A measure which can be applied in any case for preventing the loss of thermic energy from the saturation part 15 at night, for example, when a device according to FIGS. 1 and 3 is used, consists in stopping-the water supply to this saturation part 15 at a certain time before sunset by closing the expansion valves 34 and to vaporize all water still present in this saturation part 15 and subsequently to superheat it in the superheating part 16.

The aforementioned time thus must be chosen or estimated such that, after stopping the water supply, sufficient solar energy may be expected for enabling this complete vaporization of the water and the superheating of the steam.

The form of embodiment represented in FIG. 5 substantially differs from the device represented in FIGS. 1 to 3 in that expansion valves 34 are replaced by injectors 61 which, by means of an injection conduit 62, are connected to a common branch 63 of the collector pipe 40. In this branch 63, an adjustment valve 64 is arranged.

Instead of producing steam at the inlets 33 at the location by expanding the water of the heating part 14, pure steam, in the example saturated steam, is injected into the water from outside.

In all forms of embodiment, in the evening steam is supplied to the turbine 6 as long as possible. When the pressure of the steam becomes too low, this steam possibly still can be used for desalting the water.

In all forms of embodiment, an improved efficiency of the device is obtained and thus the solar energy can be better utilized.

The invention is in no way limited to the form of embodiment described heretofore and represented in the figures, on the contrary may such method and device for producing steam be realized in different variants without leaving the scope of the invention.

1.- Method for producing steam by means of solar energy, whereby water is brought into a field of tubes (1) comprising a number of approximately horizontal metal tubes (2) and concentrators (3) of solar radiation directed onto these tubes (2), whereby in a heating part (14) of this field of tubes (1), water is heated, this water, in a saturation part (15) of the field of tubes (1) having a number of parallel tubes (2) connecting to the heating part (14), is transformed into saturated steam and, in a superheating part (16) of the field of tubes (1), the saturated steam is superheated, characterized in that, in the parallel tubes (2) of the saturation part (15) connecting to the heating part (14), an amount of steam is supplied with such a speed that the water flows in these tubes (2) in a tubular shape against the interior wall.

2.- Method according to claim 1, characterized in that the water supplied from the heating part (14) to the parallel tubes (2) of the saturation part (15) is expanded at the inlet of these tubes (2), such that, by the pressure drop, steam is generated immediately, and this with such a speed that the water flows in the tubes (2) in a tubular shape against the interior wall.

3.- Method according to claim 2, characterized in that the expansion of the supplied warm water is regulated such that the speed of the water is between 0.1 and 1 m/s and the speed of the steam between 0.6 and 2.5 m/s.

4.- Method according to claim 2 or 3, characterized in that the expansion takes place with a pressure drop of approximately 50 bar.

5.- Method according to any of the preceding claims, characterized in that, after sunset, the hot water still present in the heating part (14), instead of being added to the saturation part (15), is stored in a thermically insulated reservoir (22) and, when the sun is rising, the stored and still hot water from the reservoir (22) is supplied to the heating part (14) again.

6.- Method according to any of the preceding claims, characterized in that it, at sunset or when the sun during the day ceases to shine, the water which is in the saturation part (15) is pumped to a thermically insulated reservoir (53), and at sunrise or when the sun starts shining again, the stored hot water from the reservoir (53) is brought back into the saturation part (15).

7.- Method according to any of the claims 1 to 5, characterized in that the water which, at sunset, is in the saturation part (15), still entirely is transformed into saturated steam and is superheated in the superheating part (16) as long as sufficient solar energy is present, and to this aim, the supply of water to the saturation part (15) is closed off at a certain time before sunset.

8.- Device for producing steam by means of solar energy, which device comprises at least one field of tubes (1) comprising a number of approximately horizontal metal tubes (2) and concentrators (3) of solar radiation directed onto these tubes (2), whereby this field of tubes (1) comprises a heating part (14) for heating water, a saturation part (15) with at least a number of parallel tubes (2) connecting to the heating part (14) for transforming this water into saturated steam, and a superheating part (16) for superheating the steam, characterized in that at the inlet (33) of the parallel tubes (2) of the saturation part (15) connecting to the heating part (14), means are present for bringing steam into said tubes (2).

9.- Device according to claim 8, characterized in that these means are formed by an adjustable expansion valve (34) in the inlet (33) of the tubes (2) connected to the heating part (14).

10.- Device according to claim 8 or 9, characterized in that the heating part (14) comprises a thermically insulated reservoir (22), the outlet (26) of which is connected to the inlet (18) of the heating part (14), whereas a return conduit (24) connects the outlet (25) of this heating part (14) to the inlet (23) of the reservoir (22).

11.- Device according to claim 10, characterized in that the heating part (14) comprises a number of tubes (2) connected to each other in series.

12.- Device according to any of the claims 8 to 11, characterized in that the saturation part (14) comprises a first group (15A) of tubes (2) arranged parallel to each other, which tubes are connected with one extremity to the outlet (25) of the heating part (14) and with their other extremity are connected to a collector pipe (37) and a second group (15B) of tubes (2) arranged in a parallel manner, one extremity of which is connected to said collector pipe (27) and the other extremity to a collector pipe (40).

13.- Device according to any of the claims 8 to 12, characterized in that-the saturation part (15) comprises a thermically insulated reservoir (53), the inlet (57) of which is connected to the outlet of the saturation part (15), and the outlet (60) is in connection with the extremity, distant from the inlet (33), of the parallel tubes (2) which are connected to the heating part (14).
